(19) United States
(12) Patent Application Publication
(10) Pub. No.: US 2012/0300260 A1
(43) Pub. Date: Nov. 29, 2012

(54) PRINTING APPARATUS WITH SEMICONDUCTOR NONVOLATILE STORAGE DEVICE, AND CONTROL METHOD THEREFOR

(75) Inventor: Masahiro Takizawa, Tokyo (JP)

(73) Assignee: CANON KABUSHIKI KAISHA, Tokyo (JP)

(21) Appl. No.: 13/478,286

(22) Filed: May 23, 2012

(30) Foreign Application Priority Data
May 24, 2011 (JP) 2011-115788

(51) Int. Cl. G06K 15/02

(52) U.S. Cl. 358/1.16

(57) ABSTRACT

A printing apparatus that is capable of preventing a reduction of read rate and recovering a read error. A control unit manages controls of the entire apparatus. A storage unit is provided with a semiconductor nonvolatile storage device that is controlled by the control unit to store data and a storage control unit with a function that executes a refreshment operation for the semiconductor nonvolatile storage device at the time of reading the data. The control unit suppresses the refreshment operation when detecting an execution of a processing operation that requires a high processing speed, and permits the refreshment operation after the end the processing operation that requires the high processing speed.

### BACKGROUND OF THE INVENTION

1. Field of the Invention

The present invention relates to a printing apparatus with a semiconductor nonvolatile storage device, and a control method therefor. For example, the present invention relates to a printing apparatus equipped with an SSD (Solid State Drive) that is provided with a NAND flash memory, and a control method therefor.

2. Description of the Related Art

When a conventional printing apparatus equipped with an HDD (Hard Disk Drive) performs a print operation, print data is temporarily stored in the HDD, and then read from the HDD for printing. Therefore, an access speed of the HDD becomes a bottleneck of the print operation by the conventional printing apparatus. Thus some conventional printing apparatuses aim to improve the access speed using a configuration that operates a plurality of HDD's in parallel.

A printing apparatus using an SSD, which saves power consumption, has higher shock resistance, has a high speed in data transfer, and has a high reading speed at the time of random access as compared with an HDD, is developed. Since the SSD is connectable with interfaces (IDE, SATA, SAS, etc.) compatible with the HDD, it can be easily mounted in a printing apparatus. Therefore, when a printing apparatus is equipped with the SSD instead of the HDD, the speed of a printing process is improved. When a plurality of SSD's operate in parallel, a printing speed is further improved.

The SSD used in this way is constituted as a NAND flash memory, in general. Hereafter, the SSD using the NAND flash memory is called an SSD, except where specifically noted. Hereafter, the NAND flash memory is called a flash memory, except where specifically noted.

In such a flash memory, an electric charge carried by a cell of the flash memory tends to decrease as a semiconductor manufacturing process becomes finer. Therefore, the flash memory easily causes a read error called a data corruption, when an electric charge in a cell increases or decreases slightly.

The read error is caused by the following two main causes. The first cause is a phenomenon called data retention in which an electric charge is poured to a floating gate or an electric charge is emitted from a floating gate with the passage of time. The data retention occurs by charging of the floating gate due to high voltage impression to a cell or by leak due to deficit of gate oxide, and occurs also in the state of power OFF. In a flash memory, since more electric charges are poured or emitted as a programming count or an erasing count increases, the data retention occurs easily.

The second cause is a bit error called Read Disturb generated by repeating a read operation. This bit error occurs by repeating the read operation. That is, the repeating of the read operation applies voltage to a control gate of a memory cell, which emits an electric charge into a floating gate and destroys stored data.

In order to prevent such a read error, for example, Japanese Laid-Open Patent Publication (Kokai) No. 2009-223876 (JP 2009-223876A) discloses a technique that sets up a refreshment (reprogramming) management table in a flash memory device, manages the data reading count and the erasing count for every block, and executes refreshment when the data reading count of the block reaches a predetermined threshold value. By executing such a refreshment operation, the data error in the flash memory is recoverable.

On the other hand, Japanese Laid-Open Patent Publication (Kokai) No. 2004-326867 (JP 2004-326867A) discloses a technique that sets up an error bit detection circuit and an error correction circuit (ECC) in a flash memory controller, and executes refreshment (reprogramming) when the error bit count reaches a predetermined threshold value. According to this technique, the refreshment operation recovers a data error and prevents a read error.

However, the refreshment operation for preventing a read error in a flash memory lowers a read rate significantly. A NAND flash memory is designed so as to program data in a unit of page after erasing data in a unit of block (two or more pages). Therefore, when executing the refreshment, a NAND flash memory temporarily saves data in all pages in a block, erases the data in the block, and then restores the saved data to all the pages in the block. When a block contains 64 pages, for example, a NAND flash memory needs the reading time for 64 pages, the erasing time for one block, and the programming time for 64 pages in order to execute refreshment for one page. Thus, the refreshment takes time of several tens of times of reading data in one page. Simultaneously, useful life of an SSD becomes shorter as the erasing operation and the programming operation at the time of refreshment increase.

In printing apparatuses, when refreshment of a flash memory is executed during a printing operation, the read rate for printing data becomes slower, which may cause a reduction of the printing speed, a paper jam, an ejection of a blank sheet, formation of a poor print image, a malfunction, etc.

A general SLC NAND flash memory causes the Read Disturb of one time per the reading count of 100,000 through 1,000,000 times. An MLC NAND flash memory causes the Read Disturb of one time per the reading count of 10,000 through 100,000 times. Therefore, the more memory cells in a flash memory are affected with increasing reading count.

Since blocks for storing print data in a flash memory of a printing apparatus are few in the reading count after writing the print data, the Read Disturb does not occur easily in such blocks.

However, the Read Disturb may occur in blocks for storing a boot program etc., which are read frequently but are written infrequently, in a flash memory from the following causes.

That is, a flash memory comprises a plurality of memory cells connected in a matrix form. In a flash memory, when reading a page, unselected memory cells that are connected to a selected page select line and unselected memory cells that are connected to a selected bit select line are affected by the Read Disturb. Then, in a flash memory, since the error detection and the error correction by reading a page in unselected memory cells are not executed, the Read Disturb occurs. Therefore, an unrecoverable read error may occur in a flash memory, when the refreshment is suppressed while not printing.

### SUMMARY OF THE INVENTION

The present invention provides a printing apparatus with a semiconductor nonvolatile storage device and a control method therefor, which are capable of preventing a reduction of read rate and recovering a read error.

Accordingly, a first aspect of the present invention provides a printing apparatus comprising a control unit configured to manage controls of the entire apparatus, and a storage unit configured to be provided with a semiconductor nonvolatile storage device that is controlled by the control unit to store data and a storage control unit with a function that executes a refreshment operation for the semiconductor nonvolatile storage device at the time of reading the data. The control unit suppresses the refreshment operation when detecting an execution of a processing operation that requires a high processing speed, and permits the refreshment operation after the end the processing operation that requires the high processing speed.

Accordingly, a second aspect of the present invention provides a printing apparatus comprising a control unit configured to manage controls of the entire apparatus, a storage unit configured to be provided with a semiconductor nonvolatile storage device that is controlled by the control unit to store data and a storage control unit with a function that executes a refreshment operation for the semiconductor nonvolatile storage device at the time of reading the data, and a copy count determination unit configured to determine the number of copies printed by a print job. The control unit controls the storage control unit to permit the refreshment operation when the copy count determination unit determines that a plurality of copies will be printed, and to prohibit the refreshment operation when the copy count determination unit determines that only one copy will be printed.

Accordingly, a third aspect of the present invention provides a printing apparatus comprising a control unit configured to manage controls of the entire apparatus, a storage unit configured to be provided with a semiconductor nonvolatile storage device that is controlled by the control unit to store data and a storage control unit with a function that executes a refreshment operation for the semiconductor nonvolatile storage device at the time of reading the data, a reading count calculation unit configured to calculate the data reading count of a block including pages that are read during execution of a print job, and a first-threshold-value setting unit configured to set up a first threshold value as the data reading count that is assumed to generate a read error in the storage unit. The storage control unit compares the data reading count calculated by the reading count calculation unit and the first threshold value, executes the refreshment operation when determining that the data reading count reaches the first threshold value, and does not execute the refreshment operation when determining that the data reading count does not reaches the first threshold value.

Accordingly, a fourth aspect of the present invention provides a printing apparatus comprising a control unit configured to manage controls of the entire apparatus, a storage unit configured to be provided with a semiconductor nonvolatile storage device that is controlled by the control unit to store data and a storage control unit with a function that executes a refreshment operation for the semiconductor nonvolatile storage device at the time of reading the data, an error bit calculation unit configured to calculate an error bit count in pages that are read during execution of a print job, and a second-threshold-value setting unit configured to set up a second threshold value that defines tolerance of the error bit count. The storage control unit compares the error bit count calculated by the error bit calculation unit and the second threshold value, executes the refreshment operation when determining that the error bit count exceeds the second threshold value, and does not execute the refreshment operation when determining that the error bit count does not exceed the second threshold value.

Accordingly, a fifth aspect of the present invention provides a printing apparatus comprising a control unit configured to manage controls of the entire apparatus, a storage unit configured to be provided with a semiconductor nonvolatile storage device that is controlled by the control unit to store data and a storage control unit with a function that executes a refreshment operation for the semiconductor nonvolatile storage device at the time of reading the data, and a threshold setting unit configured to set up a threshold value for determining whether execution of the refreshment operation will be permitted. The storage unit is divided into a plurality of partitions according to features of memory contents, and the threshold setting unit sets up the threshold values for the respective partitions.

Accordingly, a sixth aspect of the present invention provides a control method for a printing apparatus that has a control unit for managing controls of the entire apparatus, and a storage unit for providing a semiconductor nonvolatile storage device that is controlled by the control unit to store data and a storage control unit with a function that executes a refreshment operation for the semiconductor nonvolatile storage device at the time of reading the data, comprising a refreshment suppression step of controlling the storage control unit so as to suppress the refreshment operation when executing a processing operation that requires a high processing speed, and a refreshment permission step of controlling the storage control unit so as to permit the refreshment operation after the end of the processing operation that requires the high processing speed.

According to the present invention, there are effects of preventing a reduction of read rate and recovering a read error.

Further features of the present invention will become apparent from the following description of exemplary embodiments with reference to the attached drawings.

### BRIEF DESCRIPTION OF THE DRAWINGS

FIG. 1 is a flowchart showing a refreshment management process executed by a printing apparatus according to an embodiment of the present invention.

FIG. 2 is a block diagram schematically showing a configuration of an important section of a printing system that is provided with the printing apparatus according to the embodiment of the present invention.

FIG. 3 is a flowchart showing a printing process executed by the printing apparatus according to the embodiment of the present invention.

FIG. 4 is a flowchart showing a multiple printing process executed by the printing apparatus according to the embodiment of the present invention.

FIG. 5 is a flowchart showing the multiple printing process when printing many copies in consideration of the Read Disturb executed by the printing apparatus according to the embodiment of the present invention.

FIG. 6 is a flowchart showing the other multiple printing process when printing many copies in consideration of the Read Disturb executed by the printing apparatus according to the embodiment of the present invention.

FIG. 7 is a schematic view showing a logical organization of memory contents in a storage unit of the printing apparatus according to the embodiment of the present invention.

FIG. 8 is a flowchart showing a refreshment control process executed by the printing apparatus according to the embodiment of the present invention.

### DESCRIPTION OF THE EMBODIMENTS

Hereafter, embodiments according to the present invention will be described in detail with reference to the drawings.

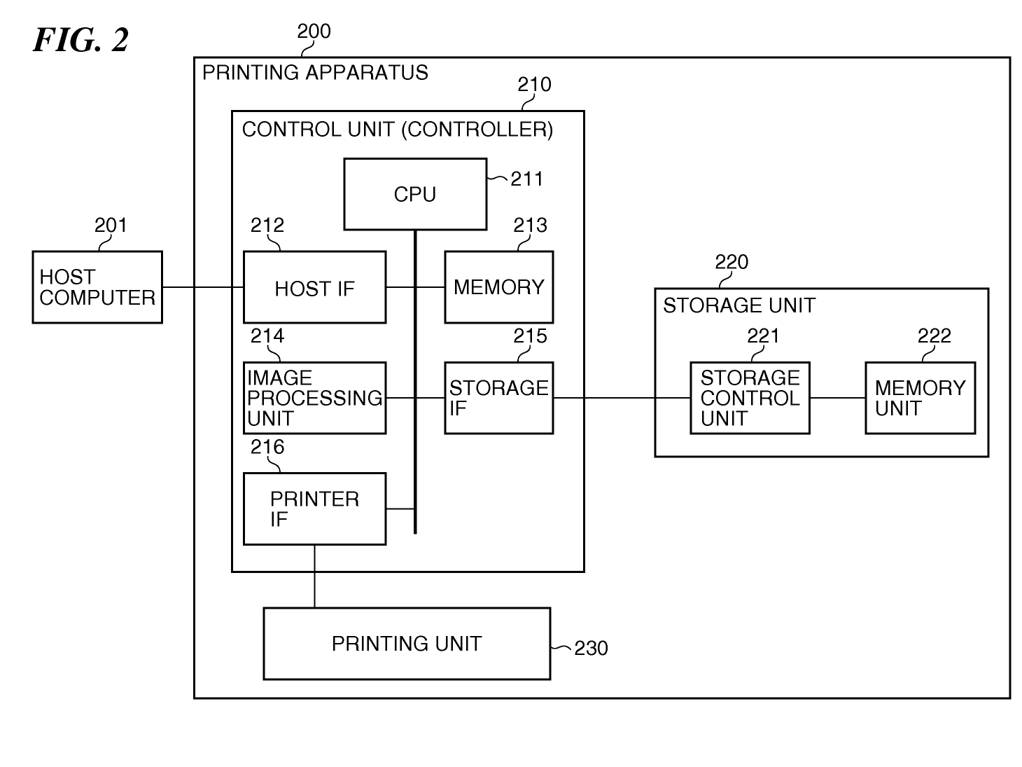

First, an important section of a printing system provided with the printing apparatus according to the embodiment will be described with reference to the block diagram in FIG. 2.

As shown in FIG. 2, the printing system comprises the printing apparatus 200 and a host computer 201 that transmits a print job to the printing apparatus 200. The printing apparatus 200 is provided with a control unit 210 that manages controls of the whole apparatus, a storage unit 220 like an SSD that temporarily stores print data, and a printing unit 230 that prints the print data onto a media like a paper sheet.

The control unit 210 is provided with a CPU 211 and a host interface 212 that communicates with the host computer 201. The host interface 212 comprises a wire interface (Ethernet (Trademark), USB, IEEE 1284, an optical fiber, or the like), for example. The host interface 212 may comprise a wireless interface (wireless LAN, Bluetooth, infrared ray communication, or the like).

The control unit 210 is provided with a memory 213 written and read by the CPU 211, an image processing unit 214 that generates image data for printing, a storage interface 215 connected with the storage unit 220, and a printer interface 216 connected with the printing unit 230.

The storage unit 220 is provided with a storage control unit 221 that manages controls in the storage unit 220 and is connected with the control unit 210, and a memory unit 222.

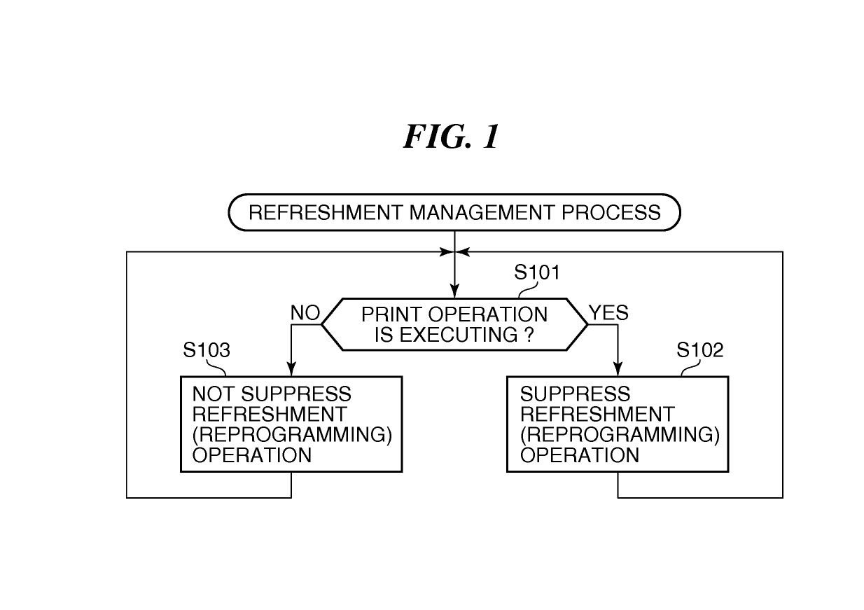

Next, a control procedure for managing a refreshment operation executed by the CPU 211 of the printing apparatus 200 in the printing system of the embodiment will be described with reference to a flowchart of a refreshment management process in FIG. 1. The program for executing the refreshment management process is stored in a ROM or an HDD (not shown) in the storage unit 220 or the control unit 210.

When the printing apparatus 200 becomes ready to print, the refreshment management process starts. In the refreshment management process, the CPU 211 determines whether the printing apparatus 200 is executing a print operation (step S101). When it is determined that the apparatus is printing (YES in the step S101), the CPU 211 proceeds with the process to step S102. When determining that it is not printing (NO in the step S101), the CPU 211 proceeds with the process to step S103.

In the step S102, the CPU 211 suppresses a refreshment (reprogramming) operation of the storage unit 220. For example, the CPU 211 transmits a command so that the storage unit 220 suppresses the refreshment operation. Here, the suppression of the refreshment operation means to prohibit the refreshment or to lower the frequency of execution of the refreshment operation by changing a threshold value that is used for determining whether the refreshment operation is executed. That is, the CPU 211 has a function as a threshold setting unit that sets up the threshold value that is used for determining whether the refreshment operation is executed. It should be noted that a process in the case of suppressing the refreshment operation will be described later.

Thus, when the refreshment operation is suppressed by the storage unit 220, the access speed at the time of reading in the storage unit 220 increases.

In the step S103, the CPU 211 does not suppress the refreshment (reprogramming) operation in the storage unit 220. For example, the CPU 211 transmits a command so that the storage unit 220 does not suppress the refreshment operation.

This makes the printing apparatus 200 execute the refreshment operation when it is not printing (for example, during a facsimile operation or a scanning operation). Therefore, since the printing apparatus 200 recovers memory contents of the storage unit 220 by executing the refreshment operation, an occurrence of read error in the storage unit 220 is suppressed.

Namely, since the printing apparatus 200 suppresses the refreshment operation when printing and executes the refreshment operation except when printing by executing the above-mentioned refreshment management process, occurrence of the read error in the storage unit 220 is suppressed without significant reduction of the read rate when printing.

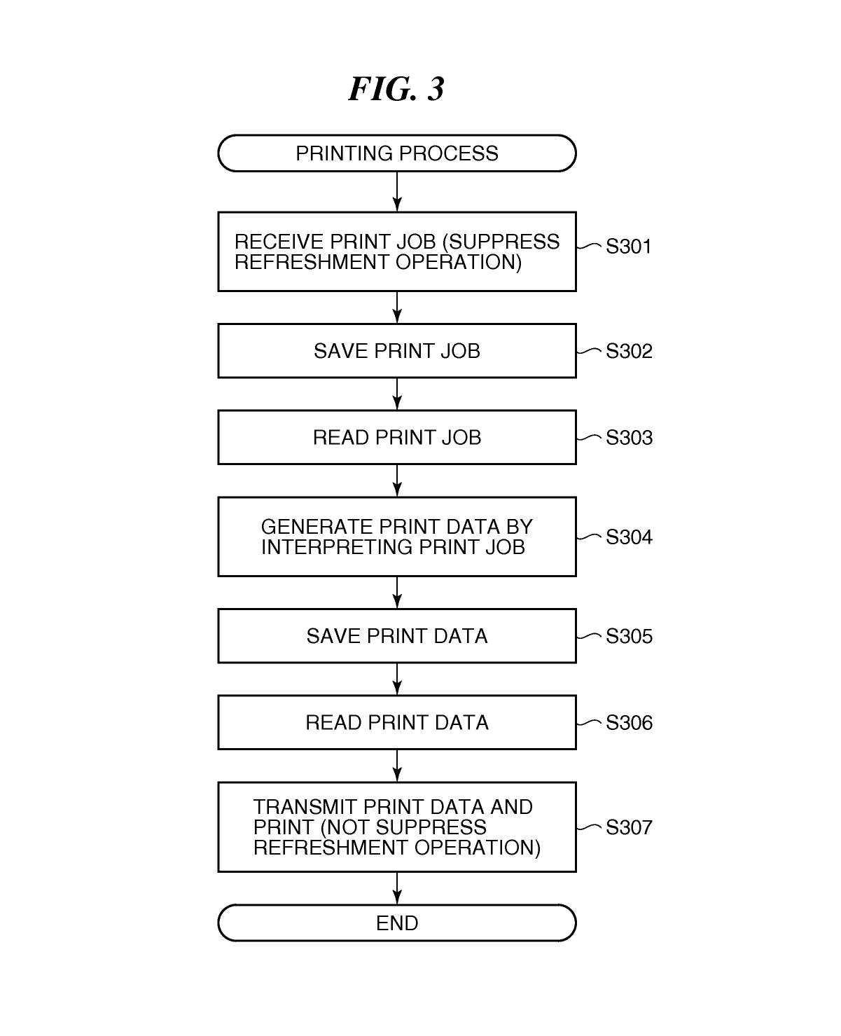

Next, procedures of a printing process executed by the CPU 211 of the printing apparatus 200 will be described with reference to a flowchart in FIG. 3. The printing process shown in FIG. 3 is equivalent to the concrete example of the refreshment management process shown in the FIG. 1 mentioned above. The program for executing the printing process is stored in the memory 213, a ROM or an HDD (not shown) in the storage unit 220 or the control unit 210. It should be noted that the description assumes that the program stored in the ROM or the HDD in the storage unit 220 or the control unit 210 is read to the memory 213, and is executed by the CPU 211, for the convenience of description.

In the printing system of the embodiment, when the host computer 201 that received a print command from a user transmits a print job to the printing apparatus 200, the printing process starts. When the printing process starts, the CPU 211 starts to receive a print job via the host interface 212. In addition, the CPU 211 sets up the storage control unit 221 so as to suppress the refreshment operation because the printing apparatus is printing (step S301).

Next, the CPU 211 saves the received print job into the memory 213 (step S302). When the size of the print job is too large to be saved in the memory 213, or when the print job cannot be interpreted from a head, the CPU 211 saves the print job into the storage unit 220 by activating the storage interface 215.

Next, the CPU 211 reads the print job saved in the memory 213 or the storage unit 220 (step S303), makes the image processing unit 214 interpret the print job to generate print data (step S304).

Next, the CPU 211 saves the print data in the memory 213 (step S305). When the size of the print data is too large to be saved in the memory 213, or when a plurality of copies will be printed, the CPU 211 saves the print data into the storage unit 220 by activating the storage interface 215. Next, the CPU 211 reads the print data of one page from the memory 213 or the storage unit 220 (step S306).

Next, the CPU 211 transmits the read print data to the printing unit 230 by activating the printer interface 216, sets up the storage control unit 221 so as not to suppress the refreshment operation (step S307), and finishes the printing process. The printing unit 230 prints the print data onto a media like a paper sheet.

When the printing apparatus 200 executes the printing process, the significant reduction of the read rate due to the refreshment operation can be avoided.

It should be noted that the printing apparatus 200 may finish the printing process when all the printed sheets have been ejected in the step S101 of the refreshment management process shown in the FIG. 1 or the step S307 of the printing process shown in FIG. 3.

The printing apparatus 200 may branch the process to the step S103 (the refreshment operation is not suppressed) in the refreshment management process shown in the FIG. 1, when determining that the printing operation is finished before all the printed sheets have not been ejected. For example, since the print data will be never read after reading the print data of the last copy when printing a plurality of copies, the printing apparatus 200 determines that the printing process is finished when the print data of the last copy but one has been read.

The printing process in FIG. 3 shows the example that the CPU 211 sets so as not to suppress the refreshment operation after the print data on the memory 213 is transmitted to the printing unit 230 in the step S307. However, the CPU 211 may set so as not to suppress the refreshment operation after the print data is read from the storage unit 220 or the memory 213 in the step S306. Even in this case, a similar effect as mentioned above is obtained.

The printing process in FIG. 3 shows the configuration that gives priority to the memory 213 to save or process the print job or the print data, and uses the storage unit 220 supplementally. However, the printing apparatus 200 may give priority to the storage unit 220 to save or process parts of the print job and the print data.

The SSD used as the storage unit 220 in the printing apparatus 200 is not necessarily connected by an HDD compatibility interface (IDE, SATA, SAS, or the like). The printing apparatus 200 may use a flash memory (USB, an SD card, a CF card, eMMC, MMC, UFS, OpenNAND, or the like) as the storage unit 220.

Although the storage unit 220 of the printing apparatus 200 is described as a storage unit using a NAND flash memory, the storage unit 220 may be constituted by a storage medium having the maximum reading count such as a ferroelectric memory (FeRAM). Since a NAND flash memory has low risk of the Read Disturb when the reading count is less than the range of 10,000 through 100,000, the suppression of the refreshment operation causes no problem. However, the reading count causing the Read Disturb tends to decrease as the process pattern of the NAND flash memory becomes finer. Therefore, this case needs to determine whether the reading count is less than the count causing the Read Disturb.

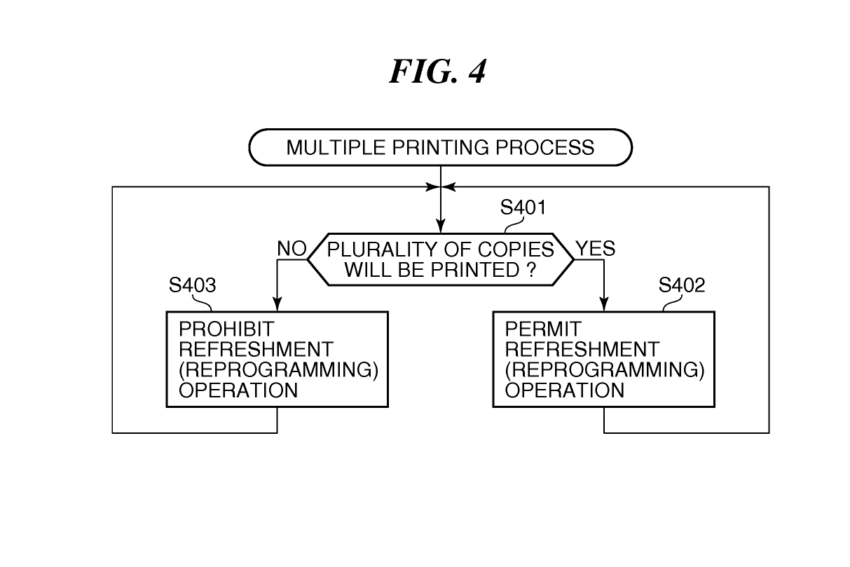

Next, procedures of a multiple printing process for printing a plurality of copies by the printing apparatus 200 will be described with reference to a flowchart in FIG. 4. Since the multiple printing process shown in FIG. 4 executes the almost similar operation as the printing process shown in the FIG. 1 mentioned above, only different sections will be described below.

When the printing operation starts, the CPU 211 (having a function as a copy count determination unit that detects the number of copies) determines whether a plurality of copies (two or more copies) will be printed (step S401). When determining that a plurality of copies will be printed (two or more copies will be printed, YES in the step S401), the CPU 211 proceeds with the process to step S402. On the other hand, when determining that a plurality of copies will not be printed (one copy will be printed, NO in the step S401) by the function as the copy count determination unit, the CPU 211 proceeds with the process to step S403. In the step S402, the CPU 211 permits the refreshment (reprogramming) operation of the storage unit of the printing apparatus. For example, the CPU 211 transmits a command so that the storage unit 220 permits the refreshment operation. In this case, since the refreshment operation recovers the memory content in the storage unit of the printing apparatus, occurrence of the read error in the storage unit of the printing apparatus is suppressed.

In the step S403, the CPU 211 prohibits the refreshment (reprogramming) operation of the storage unit 220 of the printing apparatus 200. For example, the CPU 211 transmits a command so that the storage unit 220 prohibits the refreshment operation. Thus, when the CPU 211 prohibits the refreshment operation, the access speed of the storage unit 220 of the printing apparatus 200 at reading increases. Namely, when the printing apparatus 200 executes the multiple printing process shown in FIG. 4, significant reduction of the read rate due to the refreshment operation is prevented.

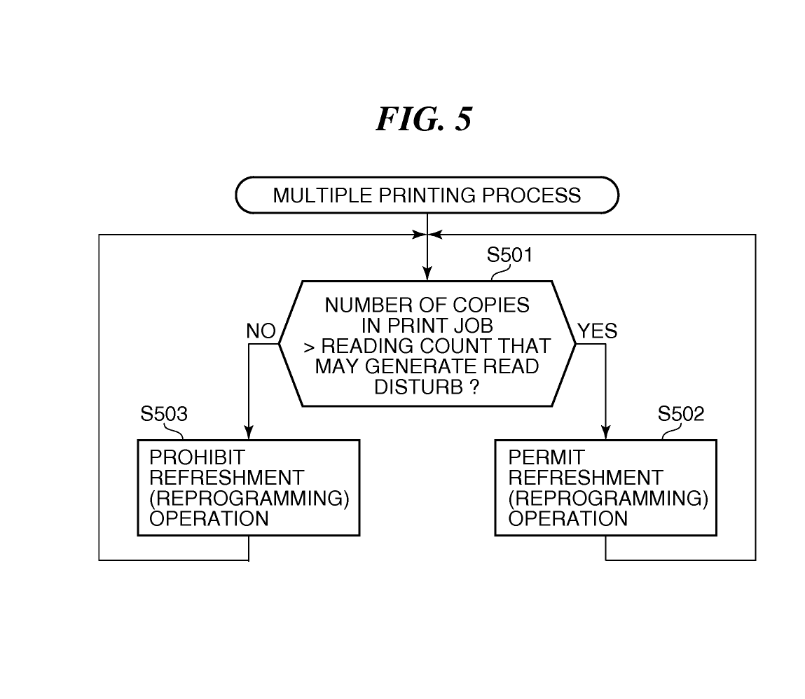

Next, procedures of a multiple printing process executed by the CPU 211 in the printing apparatus 200 for printing many copies in consideration of the Read Disturb will be described with reference to a flowchart in FIG. 5. Since the multiple printing process shown in FIG. 5 executes the almost similar operations as the printing process shown in FIG. 4 mentioned above, only different sections will be described below.

When the multiple printing process starts, the CPU 211 compares the repeated reading count that may generate the Read Disturb and the number of copies printed written in the print job in order to consider the Read-Disturb (step S501). When determining that the number of copies printed is larger than the repeated reading count that may generate the Read Disturb (YES in the step S501), the CPU 211 proceeds with the process to step S502. When determining that the number of copies printed is not larger than the repeated reading count that may generate the Read Disturb (NO in the step S501), the CPU 211 proceeds with the process to step S503. Here, since the process in the step S502 is similar to the process in the step S402 in FIG. 4 and the process in the step S503 is similar to the process in the step S403, these descriptions are omitted.

Next, an operation when the repeated reading count that generates the Read Disturb in an MLC NAND flash memory is 10,000 times will be described as an specific example of the multiple printing process shown in FIG. 5.

In this case, the CPU 211 determines whether the number of copies printed written in the print job is larger than 10,000 copies. When determining that the number of copies printed is not larger than 10,000 (NO in the step S501), the CPU 211 prohibits the refreshment operation of the storage unit 220 in the step S503. When determining that the number of copies printed is larger than 10,000 copies (YES in the step S501), the CPU 211 permits the refreshment operation of the storage unit 220 in the step S502.

When the refreshment operation is permitted in the step S502 in the multiple printing process shown in FIG. 5, the memory content of the storage unit 220 of the printing apparatus 200 is recovered, and occurrence of the read error is suppressed.

On the other hand, when the refreshment operation is prohibited in the step 503, the access speed of the storage unit 220 of the printing apparatus 200 at reading increases. Namely, since the printing apparatus 200, which executes the multiple printing process shown in FIG. 5, prohibits the refreshment operation when the number of copies printed does not generate the Read Disturb, and permits the refreshment operation when the number of copies printed may generate the Read Disturb, significant reduction of the read rate is prevented as compared with the case where the refreshment operation is always permitted.

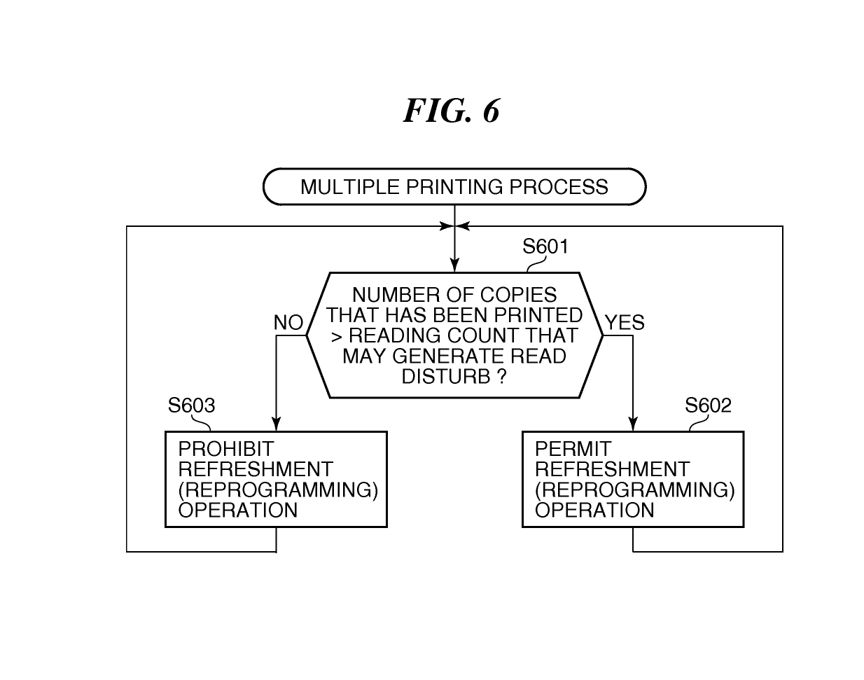

Next, procedures of another multiple printing process executed by the CPU 211 in the printing apparatus 200 for printing many copies in consideration of the Read Disturb will be described with reference to a flowchart in FIG. 6. Since the multiple printing process shown in FIG. 6 executes the almost similar operations as the printing processes shown in FIG. 4 and FIG. 5 mentioned above, only different sections will be described below.

When the multiple printing process starts, the CPU 211 compares the repeated reading count that may generate the Read Disturb and the number of copies that has been printed in order to consider the Read Disturb (step S601). When determining that the number of copies that has been printed is larger than the repeated reading count that may generate the Read Disturb (YES in the step S601), the CPU 211 proceeds with the process to step S602. When determining that the number of copies that has been printed is not larger than the repeated reading count that may generate the Read Disturb (NO in the step S601), the CPU 211 proceeds with the process to step S603. Since the process in the step S602 is similar to that in the steps S402 and S502, and the process in the step S603 is similar to that in the steps S403 and S503, these descriptions are omitted.

It should be noted that the other multiple printing process for printing many copies in consideration of the Read Disturb switches the settings of prohibition and permission of the refreshment operation during the printing operation.

Next, an operation when the number of copies printed written in the print job is 20,000 copies and the repeated reading count that generates the Read Disturb in an MLC NAND flash memory is 10,000 times will be described as an specific example of the other multiple printing process shown in FIG. 6.

In this case, the CPU 211 determines whether the number of copies that has been printed is larger than 10,000 copies in order to consider the Read Disturb. When determining that the number of copies that has been printed is not larger than 10,000 copies (NO in the step S601), the CPU 211 proceeds with the process to the step S603 and prohibits the refreshment operation of the storage unit 220. That is, since the CPU 211 prohibits the refreshment operation when the number of copies that has been printed is not larger than 10,000 copies, the access speed of the storage unit 220 of the printing apparatus 200 at reading increases, and the significant reduction of the read rate is prevented.

When determining that the number of copies that has been printed is larger than 10,000 copies (YES in the step S601), the CPU 211 permits the refreshment operation of the storage unit 220 in the step S602. That is, since the CPU 211 recovers the memory content of the storage unit 220 of the printing apparatus 200 by executing the refreshment operation when the number of copies that has been printed is larger than 10,000 copies, occurrence of the read error in the storage unit 220 is suppressed.

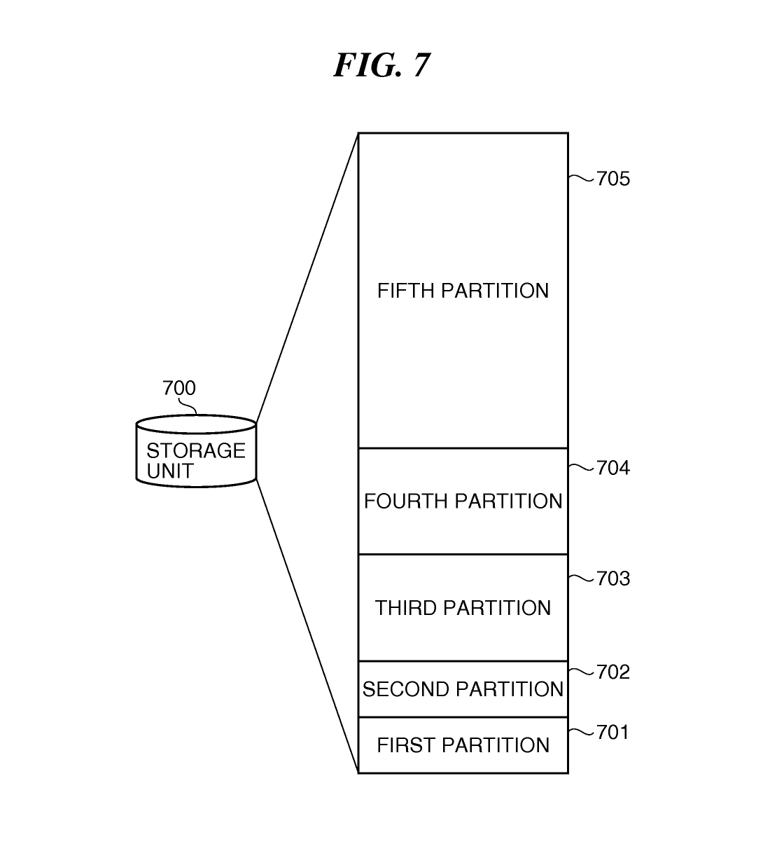

Next, a configuration where partitions are established in a storage unit in the printing apparatus 200 of the embodiment according to features of memory contents and the refreshment operation is set up for the respective partitions will be described. A logical organization of memory contents in the storage unit is constituted as shown in FIG. 7. The storage unit 700 shown in FIG. 7 is constituted like the storage unit 220 shown in FIG. 2.

The storage area of the storage unit 700 shown in FIG. 7 is logically divided into five partitions 701 through 705. These partitions 701 through 705 vary in types of files stored and operating conditions of the refreshment operation of the storage unit 700, respectively.

The first partition 701 stores a program. Since the first partition 701 is not written frequently, cells of the flash memory do not deteriorate easily. Since a data corruption in the first partition 701 causes the system to malfunction, the first partition 701 is set up so as to execute the refreshment operation easily while attaching importance to reliability.

The second partition 702 temporarily stores a PDL (Page Description Language) or a DL (intermediate language Display List) of a print job. The second partition 702 is frequently written. Since a data corruption in the second partition 702 will be conspicuous in a printed sheet, the second partition 702 is set up so as to execute the refreshment operation easily while attaching importance to reliability.

The third partition 703 stores natural images among the print data saved temporarily, and is frequently written. Since some data corruptions in the third partition 703 will not be conspicuous in a printed sheet, the third partition 703 is set up so as to execute the refreshment operation hardly.

The fourth partition 704 stores text data (character codes) or composite images (a line, a rectangle, etc. that are drawn) among the print data saved temporarily, and is frequently written. Since a data corruption in the fourth partition 704 will be conspicuous in a printed sheet, the fourth partition 704 is set up so as to execute the refreshment operation easily.

The fifth partition 705 stores preserved data, such as print data for storing (holding), a scanned image for storing, a received facsimile image, an image for composition, or print history data). Since the fifth partition 705 is not written frequently, the cells of the flash memory do not deteriorate easily. Since the fifth partition 705 stores important data for a user, the fifth partition 705 is set up so as to execute the refreshment operation easily while attaching importance to reliability.

In the storage unit 700 shown in FIG. 7, the memory contents in the partitions that are set up to execute the refreshment operation easily in the storage unit 700 of the printing apparatus 200 are recovered by executing the refreshment operation. Therefore, an occurrence of a read error is suppressed in the partitions that are set up so as to execute the refreshment operation easily.

In the storage unit 700, the refreshment operation is suppressed in the partitions that are set up so as to execute the refreshment operation hardly as mentioned above. Therefore, the access speed at reading is improved in the partitions that are set up so as to execute the refreshment operation hardly. Therefore, since the printing apparatus 200 that contains the storage unit 700 shown in FIG. 7 varies the ease of executing the refreshment operation in each of the partitions according to a type of the data stored in each partition, the significant reduction of the read rate is prevented as compared with the case where all the partitions are set up so as to execute the refreshment operation easily.

It should be noted that a plurality of logical volumes may be established instead of setting the partitions like FIG. 7 in the storage unit. In such a case, types of data stored in the respective logical volumes are defined, and fresh operating conditions are set up according to the types of data.

Since blocks for storing print data in a flash memory are few in the reading count after writing the print data, the Read Disturb does not occur easily in such blocks as mentioned above.

For example, when the printing apparatus 200 reads print data from a flash memory to the RAM by a unit of page and prints the read print data, the reading count of print data agrees with the number of print copies. Therefore, the reading count of print data is sufficiently smaller than the reading count that may generate the Read Disturb. Since the print data is generated and is printed immediately, data retention does not become a problem. Therefore, there is no problem even when suppressing the refreshment operation of the flash memory concerning blocks storing print data. On the other hand, since the Read Disturb may occur in blocks that are not written frequently (i.e., blocks storing the boot program), it is desirable to permit the refreshment operation of the flash memory for such blocks.

The above-mentioned example shown in FIG. 7 divides the memory area of the storage unit 700 into five partitions. However, the present invention does not limit the number of partitions to five, and can use the other various numbers of partitions. The embodiment mentioned above described a program, a font, a PDL, a DL, a natural image, a text, a composite image, print data for storing, scanned data for preservation, a print history, a facsimile reception image, and an image for composition as examples of files. However, the present invention is not limited to the examples of the above-mentioned files. The printing apparatus 200 does not need to be provided with all the files mentioned above, may be set up so as to suppress the refreshment operation or to permit the refreshment operation for a program and another file at least.

The embodiment mentioned above described the case where the storage unit 220 and the storage unit 700 were one drive. However, the present invention is not limited by the number of drives. The purpose of the present invention is attained, even if a plurality of drives are virtually combined into one partition as a logical volume or drives are allocated to partitions, respectively.

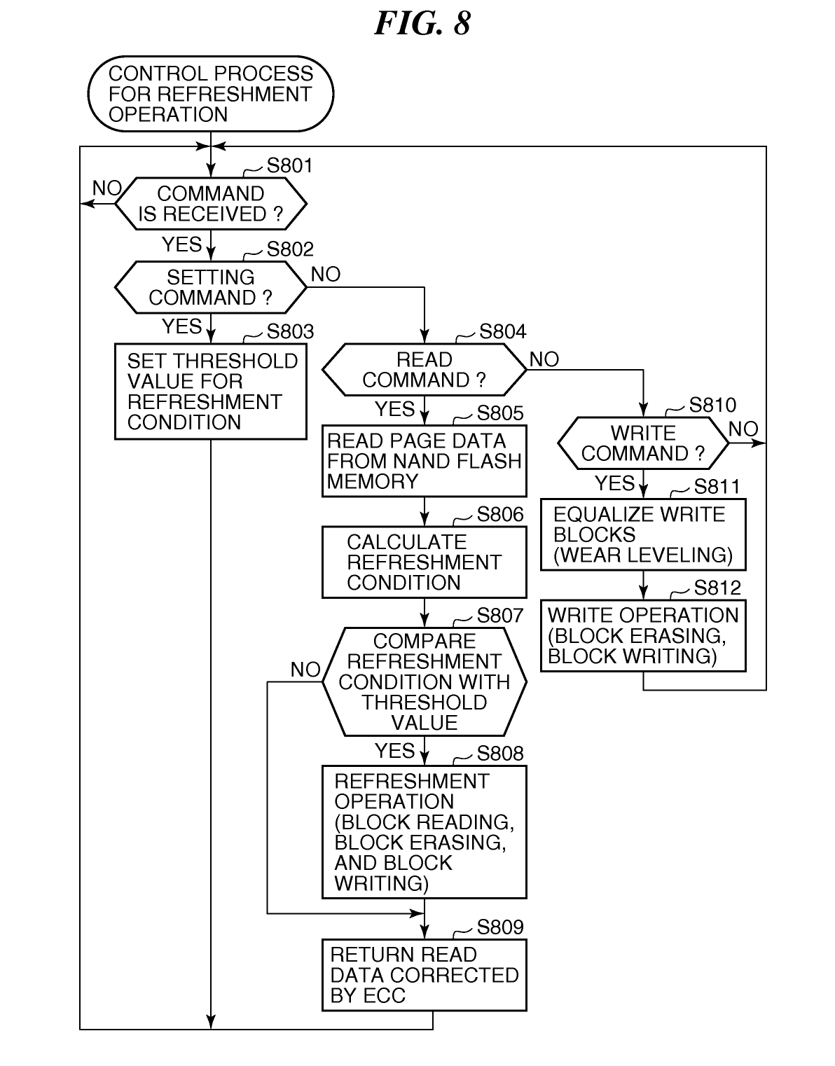

Next, a control process for the refreshment operation according to a threshold value of the refreshment operation set in the storage control unit 221 of the printing apparatus 200 and a state of the printing apparatus 200 will be described with reference to a flowchart in FIG. 8. The control process for the refreshment operation is executed when a CPU (not shown) in the storage control unit 221 executes a program stored in a ROM (not shown) in the storage control unit 221.

When the power supply of the printing apparatus 200 turns ON, the storage control unit 221 starts the control process for the refreshment operation and waits until receiving a command from the control unit 210 (NO in the step S801). When receiving a command from the control unit 210 (YES in the step S801), the storage control unit 221 proceeds with the process to step S802.

Next, the storage control unit 221 determines whether the received command is a setting command in step S802. When determining that the received command is a setting command (YES in the step S802), the storage control unit 211 proceeds with the process to step S803. When determining that it is not a setting command (NO in the step S802), the storage control unit 221 proceeds with the process to step S804.

The storage control unit 221 sets up the threshold value used as a condition of whether the refreshment operation is executed in the step S803, and returns the process to the step S801. Here, two examples of the threshold values are described.

A first threshold value is a threshold value for the data reading count that is assumed to generate a read error in the storage unit 220. The first threshold value for the data reading count is used to execute the refreshment operation based on a refresh flag, which is set to a block when the data reading count reaches a predetermined number, in the below-mentioned steps S806 through S808.

A second threshold value is a threshold value for the error bit count included in read data. The second threshold value for the error bit count is used to execute the refreshment (reprogramming) operation in the below-mentioned steps S806 through S808, when the error bit count exceeds tolerance.

Next, the storage control unit 221 determines whether the command received in the step S801 is a read command in step S804. When determining that the received command is a read command (YES in the step S804), the storage control unit 211 proceeds with the process to step S805. When determining that it is not a read command (NO in the step S804), the storage control unit 221 proceeds with the process to step S810.

The storage control unit 221 reads page data from the memory unit 222 in the step S805. Next, the storage control unit 221 calculates a refreshment condition (step S806). In the step S806, when the second threshold value is employed, the error bit count for an error checking and correcting (ECC) is calculated, and when the first threshold value is employed, the data reading count of the block including the read page is calculated.

Next, the storage control unit 221 compares the refreshment condition calculated in the step S806 and the threshold value (step S807). In the step S807, when the second threshold value is employed, the error bit count is compared with the second threshold value. When determining that the error be count is larger than the second threshold value (YES in the step S807), the storage control unit 221 proceeds with the process to step S808. When determining that the error be count is not larger than the second threshold value (NO in the step S807), the storage control unit 221 proceeds with the process to step S809. On the other hand, when the first threshold value is employed, the storage control unit 221 compares the first threshold value determined beforehand with the data reading count in the step S807. When determining that the data reading count reaches the first threshold value (YES in the step S807), the storage control unit 211 proceeds with the process to the step S808. When determining that the data reading count does not reach the first threshold value (NO in the step S807), the storage control unit 221 proceeds with the process to step S809.

Next, when the error bit count reaches the second threshold value or when the data reading count reaches the first threshold value, the storage control unit 221 performs block reading, block erasing, and block writing as the refreshment operations (the step S808), and proceeds with the process to the step S809. In the step S809, the storage control unit 221 returns the read data corrected by the ECC, and returns the process to the step S801.

When determining that the command received is not a read command in the step S804, the storage control unit 221 determines whether the command received in the step S801 is a write command (step S810). When determining that the received command is a write command (YES in the step S810), the storage control unit 211 proceeds with the process to step S811. When determining that it is not a write command (NO in the step S810), the storage control unit 221 returns the process to the step S801.

In the step S811, the storage control unit 221 determines blocks that are actually written in order to equalize write blocks for wear leveling.

Next, the storage control unit 221 performs block reading, block erasing if needed, and performs block writing by rewriting a part of read block data (step S812), and returns the process to the step S801.

As described above, in the control processing of the refreshment operation shown in FIG. 8, the storage control unit 221 sets up the threshold value of the refreshment operation received from the control unit 210. The storage control unit 221 sets up to prohibit or permit the refreshment operation, or sets up so as to execute the refreshment operation hardly or easily according to the state of the printing apparatus 200.

In short, the CPU 211 of the control unit 210 in the printing apparatus 200 of the embodiment is configured so as to manage the controls of the entire apparatus including a control of a print job and a control of the storage unit 220, etc. in the printing apparatus 200. In the storage unit 220 (SSD), the storage control unit 221 has a function to execute the refreshment operation automatically while reading or idling, for example, by a conventionally well-known method based on instructions from the CPU 211 of the control unit 210.

The printing apparatus 200 executes the refreshment operation when executing a processing operation that does not require a high processing speed, simultaneously with the read operation from the storage unit 220 (SSD). In the refreshment operation, the error of the data read from the storage unit 220 (SSD) is detected, the error is corrected, and the corrected data is again written into the storage unit 220 (SSD).

In the printing apparatus 200, when data is read from the storage unit 220 (SSD) while executing a processing operation that requires the high processing speed (for example, while executing a print job), only the read operation is executed by the storage unit 220 (SSD). It should be noted that the processing operation that requires the high processing speed is not limited to the execution of a print job, it may be execution of various programs, etc.

The CPU 211 in the printing apparatus 200 controls to prohibit the refreshment operation by the storage unit 220 during a read operation that requires the high processing speed. Accordingly, the printing apparatus 200 avoids the reduction of the read rate in the storage unit 220 when the high processing speed is required.

In the printing apparatus 200, the CPU 211 detects a start of a process (for example, a print job) that requires the high processing speed. Then, the CPU 211 is provided with a refreshment stop unit that instructs the storage control unit 221 of the storage unit 220 to stop the refreshment operation by the time when a read operation in the storage unit 220 starts for a job that requires the high processing speed. Accordingly, the CPU 211 controls so that the refreshment operation is not executed during a read operation in the storage unit 220. For example, when a print job is executed, print data is printed without correcting an error thereof.

Next, the CPU 211 instructs the storage control unit 221 to permit resumption of the refreshment operation so as to enable the resumption of the refreshment operation, after completing the read operation executed by the storage unit 220 for the job that requires the high processing speed. Accordingly, the storage control unit 221 executes the refreshment operation at a suitable time after the end of a job that requires the high processing speed or during idling. Accordingly, the printing apparatus 200 recovers memory contents in the storage unit 220 and suppresses an occurrence of a read error.

The CPU 211 transmits the instruction to stop the refreshment operation to the storage control unit 221 in order to make the storage control unit 221 suspend the refreshment operation by the time when a read operation starts in the storage unit 220. That is, the instruction to stop the refreshment operation is transmitted to the storage control unit 221 before the time when the read operation starts in the storage unit 220.

Further, the CPU 211 controls to permit the refreshment operation so as to enable the refreshment operation at the time immediately after completing the read operation executed by the storage unit 220 for the job that requires the high processing speed or at the time thereafter. Therefore, the CPU 211 may instruct to permit the refreshment operation during execution of a print job after the read operation of print data is completed and the printing of the last sheet is instructed, for example. Alternatively, the CPU 211 may instruct to permit the refreshment operation during execution of a print job, when detecting that the last printed media (sheet) is ejected onto the tray from the printing apparatus 200.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-115788, filed on May 24, 2011, which is hereby incorporated by reference herein in its entirety.

What is claimed is:

1. A printing apparatus, comprising:
a control unit configured to manage controls of the entire apparatus; and
a storage unit configured to be provided with a semiconductor nonvolatile storage device that is controlled by said control unit to store data and a storage control unit with a function that executes a refreshment operation for the semiconductor nonvolatile storage device at the time of reading the data,
wherein said control unit suppresses the refreshment operation when detecting an execution of a processing operation that requires a high processing speed, and permits the refreshment operation after the end the processing operation that requires the high processing speed.

2. The printing apparatus according to claim 1, wherein said control unit detects the execution of the processing operation that requires the high processing speed when storing a print job into said storage unit, and detects the end of the processing operation that requires the high processing speed when the last printed sheet of the print job is ejected.

3. The printing apparatus according to claim 1, wherein said control unit detects the execution of the processing operation that requires the high processing speed when storing a print job into said storage unit, and detects the end of the processing operation that requires the high processing speed when the print data of the last copy but one has been read in the case of printing a plurality of copies.

4. A printing apparatus, comprising:
a control unit configured to manage controls of the entire apparatus;
a storage unit configured to be provided with a semiconductor nonvolatile storage device that is controlled by said control unit to store data and a storage control unit with a function that executes a refreshment operation for the semiconductor nonvolatile storage device at the time of reading the data; and
a copy count determination unit configured to determine the number of copies printed by a print job,
wherein said control unit controls the storage control unit to permit the refreshment operation when said copy count determination unit determines that a plurality of copies will be printed, and to prohibit the refreshment operation when said copy count determination unit determines that only one copy will be printed.

5. A printing apparatus, comprising:
a control unit configured to manage controls of the entire apparatus;
a storage unit configured to be provided with a semiconductor nonvolatile storage device that is controlled by said control unit to store data and a storage control unit with a function that executes a refreshment operation for the semiconductor nonvolatile storage device at the time of reading the data;
a reading count calculation unit configured to calculate the data reading count of a block including pages that are read during execution of a print job; and
a first-threshold-value setting unit configured to set up a first threshold value as the data reading count that is assumed to generate a read error in said storage unit,
wherein said storage control unit compares the data reading count calculated by said reading count calculation unit and the first threshold value, executes the refreshment operation when determining that the data reading count reaches the first threshold value, and does not execute the refreshment operation when determining that the data reading count does not reaches the first threshold value.

6. A printing apparatus, comprising:
a control unit configured to manage controls of the entire apparatus;
a storage unit configured to be provided with a semiconductor nonvolatile storage device that is controlled by said control unit to store data and a storage control unit with a function that executes a refreshment operation for the semiconductor nonvolatile storage device at the time of reading the data;
an error bit calculation unit configured to calculate an error bit count in pages that are read during execution of a print job; and
a second-threshold-value setting unit configured to set up a second threshold value that defines tolerance of the error bit count,
wherein said storage control unit compares the error bit count calculated by said error bit calculation unit and the second threshold value, executes the refreshment operation when determining that the error bit count exceeds the second threshold value, and does not execute the refreshment operation when determining that the error bit count does not exceed the second threshold value.

7. A printing apparatus, comprising:
a control unit configured to manage controls of the entire apparatus;
a storage unit configured to be provided with a semiconductor nonvolatile storage device that is controlled by said control unit to store data and a storage control unit with a function that executes a refreshment operation for the semiconductor nonvolatile storage device at the time of reading the data; and
a threshold setting unit configured to set up a threshold value for determining whether execution of the refreshment operation will be permitted,
wherein said storage unit is divided into a plurality of partitions according to features of memory contents, and said threshold setting unit sets up the threshold values for the respective partitions.

8. The printing apparatus according to claim 7, wherein said threshold setting unit sets up the threshold value so as not to suppress the refreshment operation to a partition that stores a program, a Page Description Language, a Display List, text data, a composite image, print data for storing, a scanned image for storing, a received facsimile image, an image for composition, or print history data, and sets up the threshold value so as to suppress the refreshment operation to a partition that stores a natural image.

9. A control method for a printing apparatus that has a control unit for managing controls of the entire apparatus, and a storage unit for providing a semiconductor nonvolatile storage device that is controlled by said control unit to store data and a storage control unit with a function that executes a refreshment operation for the semiconductor nonvolatile storage device at the time of reading the data, the control method comprising:
a refreshment suppression step of controlling the storage control unit so as to suppress the refreshment operation when executing a processing operation that requires a high processing speed; and
a refreshment permission step of controlling the storage control unit so as to permit the refreshment operation after the end of the processing operation that requires the high processing speed.
